(19) United States
(12) Patent Application Publication
(10) Pub. No.: US 2006/0012166 A1
(43) Pub. Date: Jan. 19, 2006

(54) Articulating pipe joint

(75) Inventors: Roger Lee Siferd, Findlay, OH (US); Owen Michael Atchison, Findlay, OH (US); John Jeffery Waldman, Findlay, OH (US)

Correspondence Address: STEPHEN D. SCANLON, JONES DAY, 901 LAKESIDE AVENUE, CLEVELAND, OH, 44114, US

(73) Assignee: Hancor, Inc.

(21) Appl. No.: 11/129,904

(22) Filed: May 16, 2005

Related U.S. Application Data
(60) Provisional application No. 60/587,388, filed on Jul. 13, 2004.

(51) Int. Cl. F16L 27/00

(52) U.S. Cl. 285/184

(57) ABSTRACT

A tubular pipe joint section has a) a first circular rim portion, b) a non-coaxial second circular rim portion, and c) an elliptical body wall extending from the first circular rim portion to the second circular rim portion.

### RELATED APPLICATIONS

This application claims the benefit of Provisional U.S. Patent Application 60/587,388, filed Jul. 13, 2004, which is incorporated by reference.

### TECHNICAL FIELD

This technology relates to joints for connecting pipes in angular orientations.

### BACKGROUND

An installation of pipes, and especially those that are installed underground, may include pipes that need to be connected at an angle for which an elbow or other fixed pipe joint is unavailable. An articulating pipe joint is thus configured with tubular sections that are rotatable through a range of angular orientations relative to each other. This provides a corresponding range of angles at which pipes can be connected by the joint.

### SUMMARY

An apparatus comprises a tubular pipe joint section having a) a first circular rim portion, b) a non-coaxial second circular rim portion configured to receive the first circular rim portion of a duplicate pipe joint section coaxially in rotational sliding engagement, and c) an elliptical body wall extending from the first circular rim portion to the second circular rim portion.

### DRAWINGS

FIG. 1 is a sectional view of an articulating pipe joint.

FIG. 2 is a perspective view of the pipe joint of FIG. 1.

FIG. 3 is a sectional view of another articulating pipe joint.

FIG. 4 is a side view of another articulating pipe joint.

### DESCRIPTION

The pipe joints illustrated in the drawings have parts that are examples of the structural elements recited in the claims. The illustrated pipe joints thus include examples of how a person of ordinary skill in the art can make and use the claimed invention. They are described here to meet the enablement and best mode requirements of the patent statute without imposing limitations that are not recited in the claims.

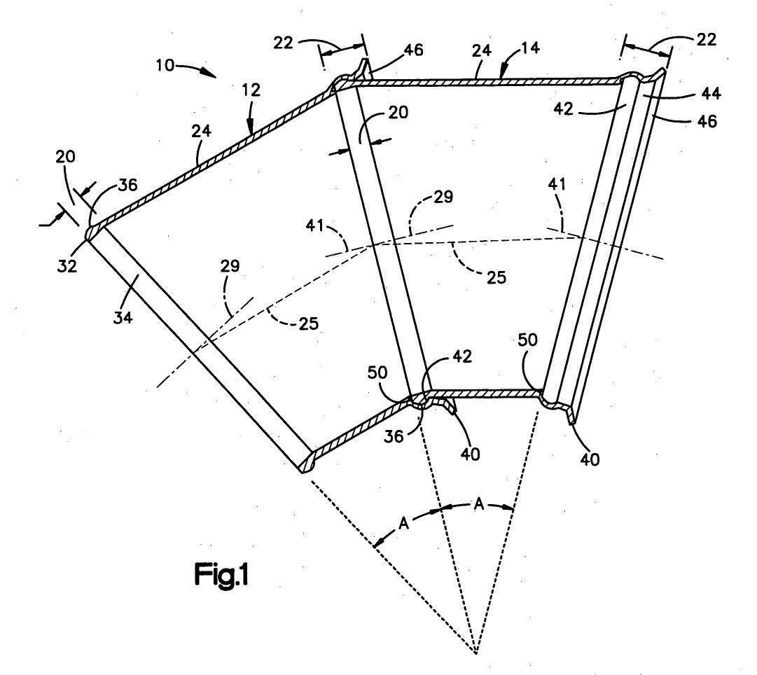

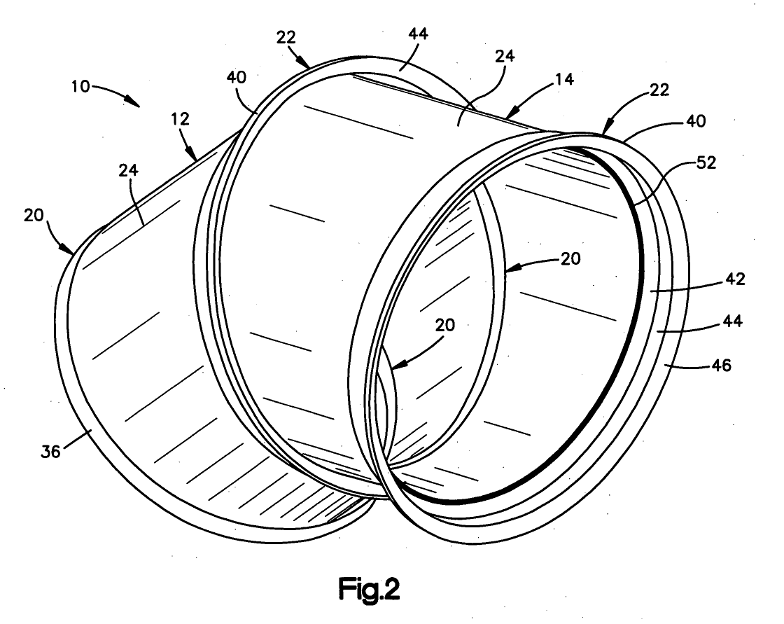

As shown in FIGS. 1 and 2, a plastic pipe joint 10 has two sections 12 and 14 connected in series. These examples of the two parts 12 and 14 of the joint 10 have the same size and shape, and are preferably formed of the same plastic material. Each has a first open end portion 20, a second open end portion 22, and a tubular body wall 24 extending longitudinally between the opposite end portions 20 and 22. The opposite end portions 20 and 22 are circular, and are offset so as not to be coaxial with each other. Here, for example, the second end portion 22 of each part 12 and 14 is inclined from the first end portion 20 at an angle A. The body walls 24, which thus extend longitudinally between non-coaxial circular end portions 20 and 22, are elliptical with longitudinal centerlines 25.

More specifically, the first end portion 20 is configured as a circular rim with a central axis 29. A planar edge surface 32 of the first end portion 20 lies in a plane perpendicular to the axis 29. An annular inner surface 34 of the first end portion 20 has a uniform diameter centered on the axis 29. An outer bearing surface 36 has a convex contour that is bowed radially outward, as shown in the cross-sectional view of FIG. 1, with a correspondingly non-uniform diameter that also is centered on the axis 29.

As best shown in FIG. 1 at the right-hand end of the second part 14, the second end portion 22 of each part 12 and 14 also is configured as a circular rim. It has a frusto-conical edge surface 40 that is centered on a corresponding axis 41. The axis 41 of one end of each part 12 or 14 is offset from the axis 29 at the other end. In this particular example, the axes 29 and 41 at the opposite ends of each part 12 and 14 are skewed relative to each other at the angle A. The angle A is preferably less than about 45° and, in the illustrated example, is about 30°. As further shown in FIG. 1, the axes 29 and 41 at the opposite ends of the parts 12 and 14 in the illustrated example are equally skewed relative to the longitudinal centerline 25 of the respective body wall 24.

The second end portion 22 of each part 12 and 14 further has three inner surfaces 42, 44 and 46. Each of the three inner surfaces 42, 44 and 46 is an annular, circular surface centered on the axis 41 at that end of the part 12 or 14. The second and third of those surfaces 44 and 46 have conical contours. The first 42 is a bearing surface with a concave contour that is bowed radially outward. That bearing surface 42 has a size and contour equal or nearly equal to the size and contour of the bearing surface 36 at the opposite end portion 20. The complementary contours of the bearing surfaces 36 and 42 enable the first end portion 20 of either part 12 and 14 to be received coaxially within the second end portion 22 of the other part 12 or 14 in rotational sliding contact at the bearing surfaces 36 and 42, as shown where these two parts 12 and 14 are joined at the center of FIG. 1.

The plastic material of which the second end portion 22 is formed, as well as the conical contours of the second and third inner surfaces 44 and 46, enable the first end portion 20 to snap into releasably interlocked engagement with the second end portion 22 upon being moved forcefully into the installed position shown at the center of FIG. 1. The fit between the two parts 12 and 14 is preferably tight enough to retain them securely together, but permits the two parts 12 and 14 to be rotated relative to each other about their central axes 29 and 41 which, as shown in FIG. 1, are coincident at the engaged end portions 20 and 22. A notch 50 beside the first inner surface 42 can receive an O-ring or other gasket or seal 52, as shown in FIG. 2.

In this arrangement, the joint 10 can interconnect a pair of pipe structures (not shown) for articulation relative to each other. A female end portion of a first pipe structure, which may comprise a pipe, a pipe fitting, or another joint part, can be received over the first end portion 20 of the first joint part 12. This can be done in a manner similar to that in which the second end portion 22 of the first joint part 12 is received over the first end portion 20 of the second joint part 14, or in any other suitable manner. A male end portion of a second pipe structure can likewise be received within the second end portion 22 of the second joint part 14. Those two pipe structures can then be rotated relative to each other upon rotation of the first and second parts 12 and 14 relative to each other as described above.

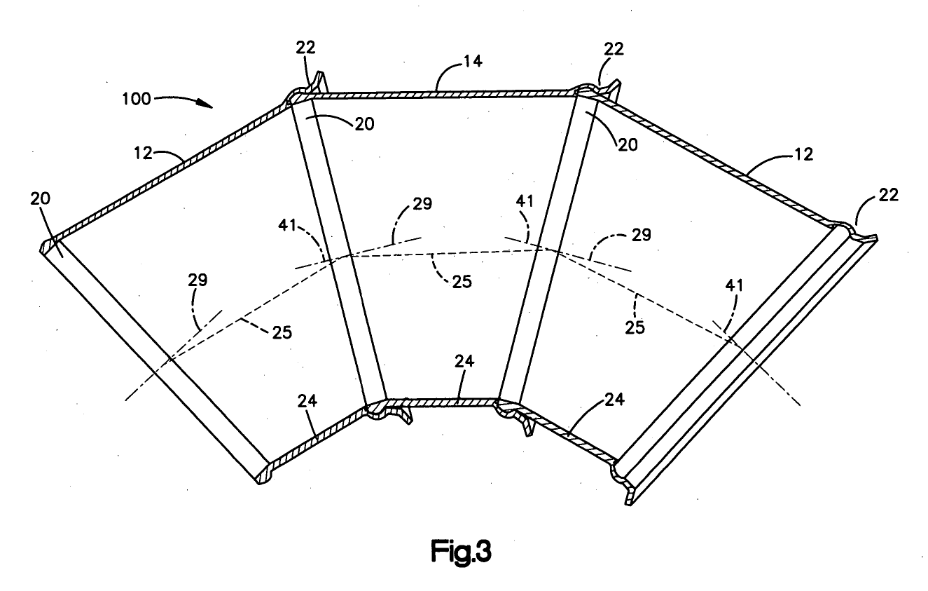

In an alternative arrangement, a single part like either of these two parts 12 and 14 could be used to interconnect two pipe structures for rotation relative to each other. A greater number of parts also could be used in a single joint 100, as shown in FIG. 3. Other alternative joint structures could include one or more joint parts with opposite ends that are inclined at angles different from the angles A shown in FIG. 1. Also, one or more joint parts in a connected series may have an angle of inclination or other axially offset configuration that differs from that of one or more of the other joint parts in the series.

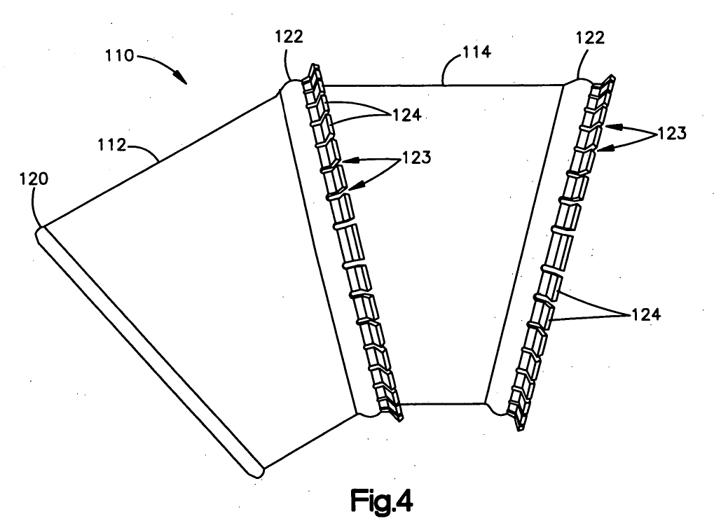

Another alternative joint 110 is shown in FIG. 4. This joint 110 has sections 112 and 114 that are the same as the sections 12 and 14 of the joints 10 and 100, except that the second end portions 122 of these joint sections 112 and 114 have notches 123. The notches 123 define separately flexible tabs 124 that facilitate radial deflection of the second end portion 122 upon insertion of a first end portion 120 (or 20).

This written description sets forth the best mode of carrying out the invention, and describes the invention so as to enable a person of ordinary skill in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they have elements with insubstantial differences from the literal language of the claims.

1. An apparatus comprising:
a tubular pipe joint section having a) a first circular rim portion, b) a non-coaxial second circular rim portion configured to receive the first circular rim portion of a duplicate pipe joint section coaxially in rotational sliding engagement, and c) an elliptical body wall extending from the first circular rim portion to the second circular rim portion.

2. An apparatus as defined in claim 1 wherein the first and second circular rim portions of the pipe joint section are centered on axes that are skewed relative to each other at an angle less than 45°.

3. An apparatus as defined in claim 2 wherein the angle is about 30°.

4. An apparatus as defined in claim 1 wherein the first and second circular rim portions of the pipe joint section are centered on axes that are equally skewed relative to the longitudinal centerline of the elliptical body wall.

5. An apparatus as defined in claim 1 wherein one circular rim portion of the pipe joint section has a convex bearing surface, and the other circular rim portion of the pipe joint section has a concave bearing surface configured to receive the convex bearing surface on a duplicate pipe joint section in rotational sliding engagement.

6. An apparatus as defined in claim 1 wherein the first and second circular rim portions of the pipe joint section are configured for the first circular rim portion to snap into releasably interlocked coaxial engagement with the second circular rim portion of a duplicate pipe joint section.

7. An apparatus as defined in claim 1 wherein the pipe joint section is formed of plastic.

8. An apparatus comprising:
a plurality of tubular pipe joint sections, each of which has a) a first circular rim portion, b) a non-coaxial second circular rim portion configured to receive the first circular rim portion of another pipe joint section coaxially in rotational sliding engagement, and c) an elliptical body wall extending from the first circular rim portion to the second circular rim portion.

9. An apparatus as defined in claim 8 wherein the first and second circular rim portions of each pipe joint section are centered on axes that are skewed relative to each other at an angle less than 45°.

10. An apparatus as defined in claim 9 wherein the angle is about 30°.

11. An apparatus as defined in claim 8 wherein the first and second circular rim portions of each pipe joint section are centered on axes that are equally skewed relative to the longitudinal centerline of the respective elliptical body wall.

12. An apparatus as defined in claim 8 wherein one circular rim portion of each pipe joint section has a convex bearing surface, and the other circular rim portion of each pipe joint section has a concave bearing surface configured to receive the convex bearing surface on another pipe joint section in rotational sliding engagement.

13. An apparatus as defined in claim 8 wherein the first and second circular rim portions of each pipe joint section are configured for the first circular rim portion to snap into releasably interlocked coaxial engagement with the second circular rim portion of another pipe joint section.

14. An apparatus as defined in claim 8 wherein the first circular rim portion of one pipe joint section is installed coaxially in rotational sliding engagement within the second circular rim portion of another pipe joint section.

15. An apparatus as defined in claim 8 wherein the pipe joint sections have the same size and shape.

16. An apparatus as defined in claim 8 wherein the pipe joint sections are formed of plastic.

17. An apparatus comprising:
a first tubular pipe joint section having a) a first circular rim portion, b) a non-coaxial second circular rim portion, and c) an elliptical body wall extending from the first circular rim portion to the second circular rim portion;
a second tubular pipe joint section having a) a first circular rim portion installed coaxially in rotational sliding engagement with the second circular rim portion of the first pipe joint section, b) a non-coaxial second circular rim portion, and c) an elliptical body wall extending from the first circular rim portion to the second circular rim portion; and
a third tubular pipe joint section having a) a first circular rim portion installed coaxially in rotational sliding engagement with the second circular rim portion of the second pipe joint section, b) a non-coaxial second circular rim portion, and c) an elliptical body wall extending from the first circular rim portion to the second circular rim portion.

18. An apparatus as defined in claim 17 wherein the first and second circular rim portions of each pipe joint section are centered on axes that are skewed relative to each other at an angle less than 45°.

19. An apparatus as defined in claim 18 wherein the angle is about 30°.

20. An apparatus as defined in claim 17 wherein one circular rim portion of each pipe joint section has a convex bearing surface, and the other circular rim portion of each pipe joint section has a concave bearing surface configured to receive the convex bearing surface on another pipe joint section in rotational sliding engagement.

21. An apparatus as defined in claim 17 wherein the first and second circular rim portions of each pipe joint section are configured for the first circular rim portion to snap into releasably interlocked coaxial engagement with the second circular rim portion of another pipe joint section.

22. An apparatus as defined in claim 17 wherein the pipe joint sections have the same size and shape.

23. An apparatus as defined in claim 17 wherein the pipe joint sections are formed of plastic.
